(19) United States
(12) Patent Application Publication
(10) Pub. No.: US 2023/0260119 A1
(43) Pub. Date: Aug. 17, 2023

(54) IMAGE PROCESSING APPARATUS, IMAGE PROCESSING METHOD, AND COMPUTER PROGRAM PRODUCT

(71) Applicant: CANON MEDICAL SYSTEMS CORPORATION, Otawara-shi (JP)

(72) Inventors: Gakuya SOEDA, Isehara (JP); Takahiko NISHIOKA, Otawara (JP)

(73) Assignee: CANON MEDICAL SYSTEMS CORPORATION, Otawara-shi (JP)

(21) Appl. No.: 18/170,252

(22) Filed: Feb. 16, 2023

(30) Foreign Application Priority Data
Feb. 16, 2022 (JP) 2022-022273

(51) Int. Cl. G06T 7/00; G06T 7/33; G06T 7/55; G06T 5/00; G06T 1/00

(52) U.S. Cl. CPC G06T 7/0012; G06T 7/33; G06T 7/55; G06T 5/003; G06T 1/0007; G06T 2207/20201; G06T 2207/30104

(57) ABSTRACT

An image processing apparatus according to an embodiment includes a processor. The processor acquires medical image data. The processor estimates the structure of a target organ depicted in the medical image data. The processor determines, for each region of the target organ, the degree of certainty representing the accuracy of the estimation result of the structure of the target organ depicted in the medical image data. The processor causes at least information indicating whether user's editing based on the degree of certainty is necessary or information representing a region where user's editing is restricted to be displayed on a display image based on the medical image data.

### CROSS-REFERENCE TO RELATED APPLICATIONS

This application is based upon and claims the benefit of priority from Japanese Patent Application No. 2022-022273, filed on Feb. 16, 2022; the entire contents of which are incorporated herein by reference.

### FIELD

The present invention relates to an image processing apparatus, an image processing method, and a computer program product.

### BACKGROUND

In the medical field, diagnosis is performed using images acquired by various imaging apparatuses (modalities) such as CT image diagnostic apparatuses. In this diagnosis, information on the volume, structure, and the like of various organs such as blood vessels in medical image data is used for diagnosis, but in order to use the information, the contour of a region concerned needs to be extracted from the image. However, manually performing this region extraction work may cause a problem of imposing a great amount of labor on an operator who performs the work. Therefore, in order to reduce operator's labor, various techniques are proposed for techniques of extracting regions automatically or semi-automatically from images.

One example is a technique of improving the accuracy of automatically extracting the running of a blood vessel as disclosed in Non-Patent Literature 1. Patent Literature 1 discloses a technique of improving the accuracy of specifying a non-blood flow region in a blood vessel. Some technologies improve the accuracy of automatic recognition by using graph theory such as Dijkstra's algorithm, or machine learning techniques such as U-Net, in order to determine running and regions of blood vessels.

A user may manually edit the results of automatic extraction of various organs such as blood vessels.

### BRIEF DESCRIPTION OF THE DRAWINGS

FIG. 1 is a diagram illustrating an example of the overall configuration of a medical image processing system according to a first embodiment;

FIG. 2 is a schematic diagram illustrating a part of volume data according to the first embodiment;

FIG. 3 is a diagram illustrating an example of segmentation according to the first embodiment;

FIG. 4 is a diagram illustrating an example of running of a blood vessel according to the first embodiment;

FIG. 5 is a diagram illustrating an example of an edit screen according to the first embodiment;

FIG. 6 is a flowchart illustrating an example of the flow of a process of analyzing a blood vessel structure according to the first embodiment;

FIG. 7 is a diagram illustrating an example of an edit screen according to a first modification of the first embodiment;

FIG. 8 is a diagram illustrating an example of a blood vessel cross-sectional image corresponding to a first cutting position in an SPR image of FIG. 7;

FIG. 9 is a diagram illustrating an example of a blood vessel cross-sectional image corresponding to a second cutting position in the SPR image of FIG. 7;

FIG. 10 is a diagram illustrating an example of a blood vessel cross-sectional image corresponding to a third cutting position in the SPR image of FIG. 7;

FIG. 11 is a diagram illustrating an example of a node-to-node search cost for a first branch of a blood vessel according to a second modification of the first embodiment;

FIG. 12 is a diagram illustrating an example of a node-to-node search cost for a second branch of the blood vessel according to the second modification of the first embodiment;

FIG. 13 is a diagram illustrating an example of a node-to-node search cost for a third branch of the blood vessel according to the second modification of the first embodiment;

FIG. 14 is a diagram illustrating an example of an edit screen according to the second modification of the first embodiment;

FIG. 15 is a diagram illustrating an example of medical image data obtained by capturing a lumen of a blood vessel according to a second embodiment;

FIG. 16 is a diagram illustrating an example of a result of estimating a lumen region of a blood vessel according to the second embodiment;

FIG. 17 is a diagram illustrating an example of an edit screen according to the second embodiment;

FIG. 18 is a diagram illustrating an example of a first cutting position 10001 to a third cutting position 10003 on the edit screen according to the second embodiment;

FIG. 19 is a diagram illustrating an example of a blood vessel cross-sectional image corresponding to the first cutting position in FIG. 18;

FIG. 20 is a diagram illustrating an example of a blood vessel cross-sectional image corresponding to the second cutting position in FIG. 18;

FIG. 21 is a diagram illustrating an example of a blood vessel cross-sectional image corresponding to the third cutting position in FIG. 18;

FIG. 22 is a diagram illustrating another example of a blood vessel cross-sectional image corresponding to the second cutting position in FIG. 18; and

FIG. 23 is a diagram illustrating an example of a table defining point deduction conditions for the degree of certainty according to the second modification of the first and second embodiments.

### DETAILED DESCRIPTION

An image processing apparatus according to an embodiment includes a processor. The processor acquires medical image data. The processor estimates the structure of a target organ depicted in the medical image data. The processor determines, for each region of the target organ, the degree of certainty representing the accuracy of the estimation result of the structure of the target organ depicted in the medical image data. The processor defines a region where editing of the estimation result by a user is restricted, on the basis of the degree of certainty.

Hereinafter, embodiments of an image processing apparatus, an image processing method, and a computer program product are described in detail with reference to the drawings. However, dimensions, materials, shapes, and relative arrangement of components to be described in the following embodiments are arbitrary and can be changed according to the configuration of an apparatus to which the invention is applied or various conditions. In the drawings, the same reference numerals are used between drawings in order to indicate elements that are identical or functionally similar.

### First Embodiment

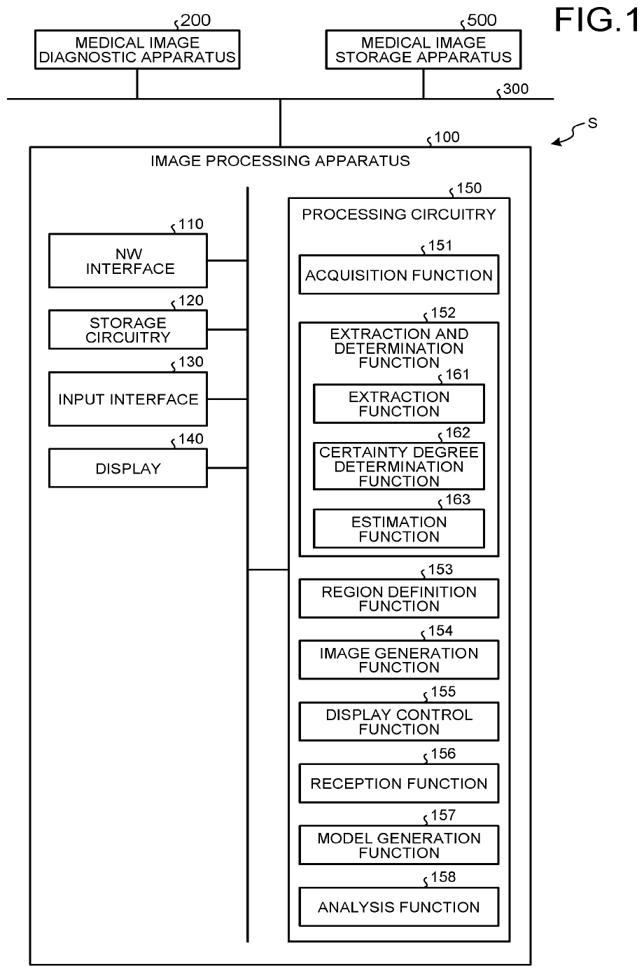

FIG. 1 is a block diagram illustrating an example of the configuration of a medical image processing system S according to a first embodiment. As illustrated in FIG. 1, the medical image processing system S includes an image processing apparatus 100, a medical image diagnostic apparatus 200, and a medical image storage apparatus 500. The image processing apparatus 100 is communicably connected to the medical image storage apparatus 500 via a network 300 such as an in-hospital local area network (LAN).

The medical image storage apparatus 500 stores medical images captured by the medical image diagnostic apparatus 200. The medical image storage apparatus 500 is, for example, a picture archiving and communication system (PACS) server apparatus that stores medical image data in a format conforming to digital imaging and communications in medicine (DICOM). The medical images are, for example, computed tomography (CT) image data, magnetic resonance image data, ultrasonic diagnostic image data, or the like, but are not limited to such data. The medical image storage apparatus 500 is implemented by, for example, computer equipment such as a database (DB) server, and stores medical image data in storage circuitry of a semiconductor memory element such as a random access memory (RAM) and a flash memory, a hard disk, an optical disc, or the like.

The medical image diagnostic apparatus 200 is, for example, an apparatus that captures medical images of a subject, such as an X-ray computed tomography (CT) apparatus, a magnetic resonance imaging (MRI) apparatus, an X-ray diagnostic apparatus, an ultrasonic diagnostic apparatus, a positron emission tomography (PET) apparatus, or a single photon emission computed tomography (SPECT) apparatus, but is not limited to such apparatuses. The medical image diagnostic apparatus 200 is also referred to as a modality. Although FIG. 1 illustrates one medical image diagnostic apparatus 200, a plurality of medical image diagnostic apparatuses 200 may be provided.

The medical images are images of the subject captured by the medical image diagnostic apparatus 200. Examples of the medical images include X-ray CT images, magnetic resonance images, and ultrasonic images, but are not limited to such images.

In the present embodiment, a case in which the medical image diagnostic apparatus 200 is an X-ray CT apparatus is described as an example.

The image processing apparatus 100 in the present embodiment acquires medical image data from the medical image diagnostic apparatus 200 or the medical image storage apparatus 500. The medical image data is, for example, volume data of coronary arteries including blood vessels captured by the medical image diagnostic apparatus 200 that is an X-ray CT apparatus. The medical image data is not limited to this example.

The image processing apparatus 100 in the present embodiment performs extraction of blood vessel core lines and segmentation of blood vessel walls on the basis of the acquired volume data, and presents an edit screen where a user can edit the results of the extraction and the segmentation. In such a case, the image processing apparatus 100 in the present embodiment supports the user's editing work by displaying a region where manual editing by the user needs to be restricted and a region where the manual editing needs to be recommended on the basis of the segmentation results of the blood vessel core lines and the blood vessel walls. The user in the present embodiment is, for example, a doctor, a medical technician, or the like.

The blood vessel wall is an example of a blood vessel contour. The blood vessel region, the blood vessel contour, and the blood vessel core line are examples of the structure of the target organ in the present embodiment. The structure of the target organ is assumed to include at least one of the blood vessel region, the blood vessel contour, and the blood vessel core line.

The following is an example of the configuration of the image processing apparatus 100 in the present embodiment.

The image processing apparatus 100 is an information processing apparatus such as a server apparatus or a personal computer (PC), and includes a network (NW) interface 110, storage circuitry 120, an input interface 130, a display 140, and processing circuitry 150.

The NW interface 110 is connected to the processing circuitry 150 and controls transmission and communication of various data performed between the image processing apparatus 100 and the medical image diagnostic apparatus 200/the medical image storage apparatus 500. The NW interface 110 is implemented by a network card, a network adapter, a network interface controller (NIC), or the like.

The storage circuitry 120 stores in advance various information used by the processing circuitry 150. For example, the storage circuitry 120 stores the medical image data acquired from the medical image diagnostic apparatus 200 or the medical image storage apparatus 500. The storage circuitry 120 also stores various computer programs. The storage circuitry 120 is a storage device such as a hard disk drive (HDD), a solid state drive (SSD), or an integrated circuit storage device that stores various information. In addition to the HDD, the SSD, or the like, the storage circuitry 120 may also be a drive device that reads and writes various information between the drive device and a portable storage medium such as a compact disc (CD), a digital versatile disc (DVD), or a flash memory, or a semiconductor memory element such as a random access memory (RAM).

The input interface 130 is implemented by a trackball, a switch button, a mouse, a keyboard, a touch pad for performing an input operation by touching an operation surface, a touch screen with integrated display screen and touch pad, non-contact input circuitry using an optical sensor, voice input circuitry, or the like, for receiving an operation from the user. The input interface 130 is connected to the processing circuitry 150, converts an input operation received from the user into an electrical signal, and outputs the electrical signal to the processing circuitry 150.

In the present specification, the input interface is not limited to only those with physical operating components such as a mouse and a keyboard. For example, an example of the input interface also includes electrical signal processing circuitry that receives electrical signals corresponding to input operations from an external input apparatus provided separately from the apparatus and outputs the electrical signals to the processing circuitry 150.

The display 140 displays various information under the control of the processing circuitry 150. For example, the display 140 outputs an interpretation viewer including medical images produced by the processing circuitry 150, a graphical user interface (GUI) for receiving various operations from the user, and the like. The display 140 is an example of a display unit.

Specifically, the display 140 is a liquid crystal display, a cathode ray tube (CRT) display, or the like. The input interface 130 and the display 140 may be integrated. For example, the input interface 130 and the display 140 may be implemented by a touch panel.

The display 140 may be provided outside the image processing apparatus 100. For example, a display of another PC or other device connected to the image processing apparatus 100 via a network may be used as an example of the display unit.

The processing circuitry 150 is a processor that reads the computer programs from the storage circuitry 120 and executes the read computer programs, thereby implementing functions corresponding to the executed computer programs. The processing circuitry 150 of the present embodiment has an acquisition function 151, an extraction and determination function 152, a region definition function 153, an image generation function 154, a display control function 155, a reception function 156, a model generation function 157, and an analysis function 158. The acquisition function 151 is an example of an acquisition unit. The extraction and determination function 152 is an example of an extraction unit, a determination unit, and an estimation unit. The region definition function 153 is an example of a region definition unit. The image generation function 154 is an example of an image generation unit. The display control function 155 is an example of a display control unit. The reception function 156 is an example of a reception unit. The model generation function 157 is an example of a model generation unit. The analysis function 158 is an example of an analysis unit.

For example, processing functions of the acquisition function 151, the extraction and determination function 152, the region definition function 153, the image generation function 154, the display control function 155, the reception function 156, the model generation function 157, and the analysis function 158, which are components of the processing circuitry 150, are stored in the storage circuitry 120 in the form of computer programs executable by a computer. The processing circuitry 150 is a processor. For example, the processing circuitry 150 reads the computer programs from the storage circuitry 120 and executes the read computer programs, thereby implementing the functions corresponding to the executed computer programs. In other words, the processing circuitry 150 in the state of reading the computer programs has the functions illustrated in the processing circuitry 150 in FIG. 1. In FIG. 1, the processing functions performed by the acquisition function 151, the extraction and determination function 152, the region definition function 153, the image generation function 154, the display control function 155, the reception function 156, the model generation function 157, and the analysis function 158 are described as being implemented by a single piece of the processor; however, a plurality of independent processors may be combined to form the processing circuitry 150 and the functions may be implemented by each processor executing the computer program. In FIG. 1, a single storage circuitry 120 is described as storing the computer program corresponding to each processing function; however, a plurality of storage circuitry may be distributedly arranged and the processing circuitry 150 may be configured to read a corresponding computer program from the individual storage circuitry.

The above explanation describes an example in which the “processor” reads a computer program corresponding to each function from the storage circuitry and executes the read computer program; however, the embodiment is not limited to this configuration. The term “processor”, for example, means circuitry such as a central processing unit (CPU), a graphics processing unit (GPU), an application specific integrated circuit (ASIC), or a programmable logic device (for example, a simple programmable logic device (SPLD), a complex programmable logic device (CPLD), and a field programmable gate array (FPGA)). When the processor is, for example, a CPU, the processor implements functions by reading the computer programs stored in the storage circuitry and executing the read computer programs. On the other hand, when the processor is an ASIC, the functions are directly incorporated in the circuitry of the processor as logic circuitry, instead of storing the computer programs in the storage circuitry 120. Each processor of the present embodiment is not limited to being configured as single piece of circuitry for each processor, and one processor may be configured by combining a plurality of pieces of independent circuitry to implement the functions thereof. The plurality of components in FIG. 1 may be integrated into one processor to implement the functions thereof.

The acquisition function 151 acquires the medical image data obtained by capturing the subject from the medical image storage apparatus 500 or the medical image diagnostic apparatus 200 via the network 300 and the NW interface 110. As described above, the medical image data is, for example, volume data of coronary arteries including blood vessels captured by the medical image diagnostic apparatus 200 that is an X-ray CT apparatus.

The extraction and determination function 152 estimates the structure of the target organ depicted in the medical image data, and determines, for each region of the target organ, the degree of certainty representing the accuracy of the estimation result of the structure of the target organ depicted in the medical image data.

In the present embodiment, the extraction and determination function 152 includes an extraction function 161, a certainty degree determination function 162, and an estimation function 163. The extraction function 161, the certainty degree determination function 162, and the estimation function 163 may be independent as separate functions.

The extraction function 161 extracts a target organ from the acquired volume data by segmenting the volume data. More specifically, the extraction function 161 of the present embodiment extracts a blood vessel core line and a vessel wall from the acquired volume data. The target organ in the present embodiment is a blood vessel.

The extraction function 161 may extract only one of the blood vessel core line and the blood vessel wall.

The certainty degree determination function 162 also calculates the degree of certainty of the extraction of the extracted blood vessel core line and blood vessel wall.

The degree of certainty is an index representing the accuracy of the extracted blood vessel core line and blood vessel wall. For example, the accuracy of automatic extraction by the extraction function 161 may be reduced depending on the state of the blood vessel or the surroundings of the blood vessel. The accuracy of the extracted blood vessel wall is the accuracy of the contour of the extracted blood vessel wall. In a region with a high possibility that the accuracy of automatic extraction by the extraction function 161 is high, the degree of certainty is high. In a region with a high possibility that the accuracy of automatic extraction by the extraction function 161 is low, the degree of certainty is low. The certainty degree determination function 162 may calculate the degree of certainty of only one of the blood vessel core line the blood vessel wall.

The estimation function 163 estimates the blood vessel structure by using the degree of certainty. In other words, the extraction and determination function 152 analyzes the acquired volume data and calculates the blood vessel structure and the region-specific degree of certainty of the blood vessel structure.

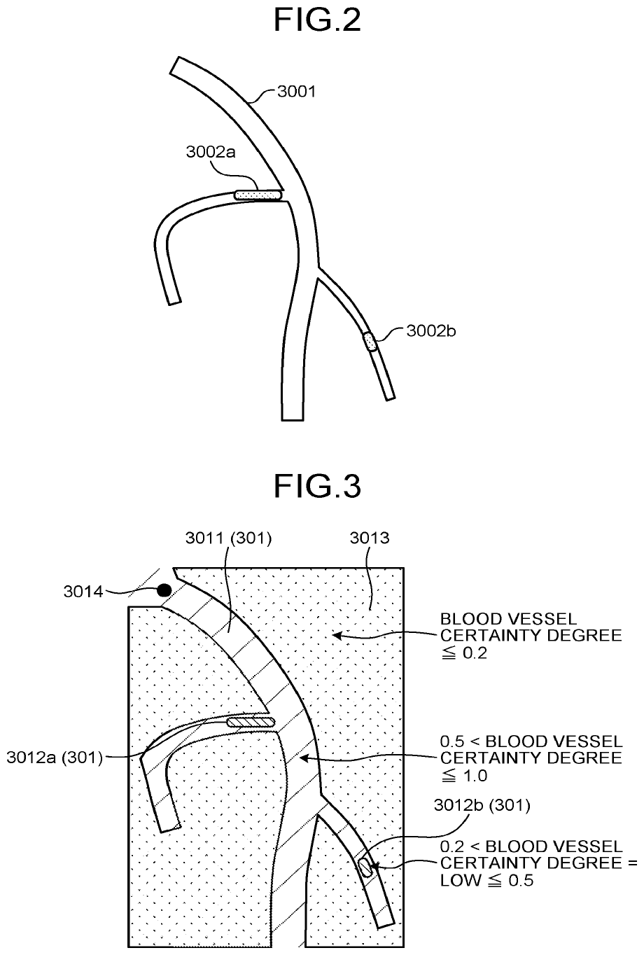

FIG. 2 is a schematic diagram illustrating a part of the volume data according to the first embodiment. A blood vessel 3001 illustrated in FIG. 2 branches into a plurality of blood vessels from an upper side to a lower side of FIG. 2. In the lumen of the blood vessel 3001, stenosis partially occurs due to plaques 3002a and 3002b.

The extraction function 161 performs image segmentation of two categories of “blood vessel” and “background” on the acquired volume data. The segmentation may be performed using a deep learning method such as U-Net or a method such as threshold determination or region search using pixel values. The extraction function 161 may also perform segmentation by using other machine learning methods.

A trained model for deep learning or another machine learning such as U-Net used for image segmentation may output pixel-by-pixel degree of certainty together with segmentation results. The trained model for deep learning or another machine learning may be stored in the storage circuitry 120, for example, and the extraction function 161 may read the trained model from the storage circuitry 120 and input the volume data into the trained model. Alternatively, the trained model may be incorporated into the extraction function 161 itself.

FIG. 3 is a diagram illustrating an example of segmentation according to the first embodiment. The extraction function 161 extracts, for example, a region 3011 of a normal blood vessel, plaque regions 3012a and 3012b, and a background region 3013 outside the blood vessel.

The plaque regions 3012a and 3012b are regions where soft plaque with accumulated cholesterol or the like or hard plaque with advanced calcification or the like is depicted. The hard plaque with advanced calcification or the like includes a large amount of calcium.

FIG. 3 also illustrates the degree of certainty determined by the certainty degree determination function 162 on the basis of the segmentation by the extraction function 161. In FIG. 3, the degree of certainty is denoted as a blood vessel certainty degree because the extraction target is a blood vessel. In FIG. 3, the degree of certainty is indicated by numerical values of 0 to 1. The closer the numerical value is to 1, the higher the degree of certainty, and the closer the numerical value is to 0, the lower the degree of certainty. The notation of the degree of certainty is an example and is not limited to this notation.

In the example illustrated in FIG. 3, the degree of certainty is determined to be high in the region 3011 of the normal blood vessel and low in the plaque regions 3012a and 3012b. In the background region 3013 outside the blood vessel 3001, the degree of certainty as the blood vessel 3001 is low, for example, 0.2 to 0. In the background region 3013, the degree of certainty of the background is high. FIG. 3 illustrates the range of values of the degree of certainty for each region, but actually, the degree of certainty is set individually in units of pixels included in each region. In general, since the region 3011 of the normal blood vessel and the plaque regions 3012a and 3012b have different CT values, the extraction function 161 may discriminate the region 3011 of the normal blood vessel and the plaque regions 3012a and 3012b on the basis of the CT values.

The estimation function 163 sets a region with a blood vessel certainty degree of 0.2 or less as the background region 3013, and estimates the other regions, for example, the region 3011 of the normal blood vessel and the plaque regions 3012a and 3012b as blood vessel regions 301. The threshold for the degree of certainty for distinguishing between the background region 3013 and the blood vessel region 301 is not limited to the value of 0.2.

A location where the degree of certainty is low is not limited to a plaque region or a calcium region. For example, also in a location where the shape of the blood vessel 3001 is complicated, a location where the width of the blood vessel 3001 is narrow relative to the resolution of the medical image diagnostic apparatus 200, around branches of the blood vessel 3001, and around a treatment device such as a stent placed in the blood vessel 3001, the degree of certainty is low because the difficulty of automatic extraction of the contour of the blood vessel wall is high. The degree of certainty may also be low depending on the state of the blood vessel 3001 itself, such as meandering of the blood vessel due to myocardial infarction or arteriosclerosis. Even when the concentration of a contrast medium injected into the blood vessel 3001 for imaging is lower than the concentration in a specified range and is higher than the concentration in the specified range, the contrast of a corresponding location on the medical image data is low, so that the difficulty of automatic extraction of the contour of the blood vessel wall is high and thus the degree of certainty is low.

Then, the estimation function 163 searches for running of the blood vessel by using the blood vessel certainty degree. Specifically, the estimation function 163 first sets a search starting point 3014 within the blood vessel region 301. The estimation function 163 may automatically acquire a search starting point from the medical image data according to an organ to be analyzed (brain, heart, or the like) or a site to be analyzed (cerebral artery, coronary artery, or the like). For example, when the coronary artery is the site to be analyzed, the estimation function 163 can extract a starting portion of the coronary artery by image processing and use the starting portion as the search starting point. The reception function 156 to be described below may also receive an operation of manually designating the search starting point from an operator.

Then, the estimation function 163 sets the blood vessel region 301 as a region for generating a graph. For example, the estimation function 163 sets nodes in the graph throughout the blood vessel region 301. Then, the estimation function 163 calculates the node-to-node search cost in the graph on the basis of the blood vessel certainty degree. In such a case, the estimation function 163 sets a higher search cost as the blood vessel certainty degree of pixels between the nodes is lower. In the present embodiment, the value of “the degree of certainty between 1 to nodes” is defined as the “search cost”. The estimation function 163 determines the node-to-node degree of certainty, for example, from the degree of certainty of both neighboring nodes. The degree of certainty of a node is the degree of certainty at a pixel where the node is set. Alternatively, the degree of certainty of a node may be the mean value or median value of the degree of certainty of a plurality of pixels around the node.

Next, the estimation function 163 searches for paths from the search starting point to each node in the graph. Dijkstra's algorithm or the like may be used for the search. As a result of the search, since a plurality of paths with overlapping nodes are searched, paths with a long search distance are adopted as completely overlapping paths. Then, the finally remaining path is adopted as blood vessel running of each blood vessel. Moreover, the estimation function 163 segments the path into a plurality of sections. Then, for each segmented section, the maximum value of the node-to-node search cost in the section is assigned as the degree of unreliability of the section. That is, in the present embodiment, the degree of unreliability is an index indicating that the greater the value, the lower the reliability, and the degree of unreliability increases as the maximum value of the node-to-node search cost increases. The search cost using the Dijkstra's algorithm is an example of a path search cost in the present embodiment.

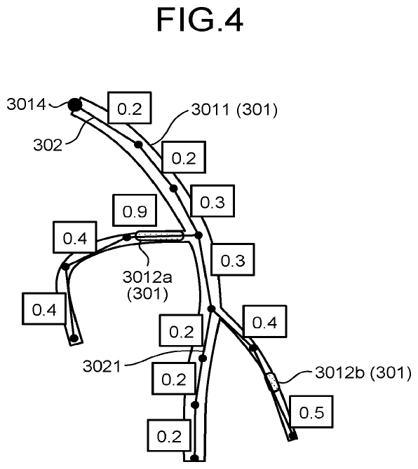

FIG. 4 is a diagram illustrating an example of a running 3021 of the blood vessel according to the first embodiment. In the present embodiment, the running of a blood vessel core line 302 of the blood vessel 3001 is referred to as blood vessel running or blood vessel structure.

The blood vessel 3001 illustrated in FIG. 4 has three branches. The extraction and determination function 152 acquires one path for each of the three branches and calculates the degree of unreliability of each section on each path. In the example illustrated in FIG. 4, a high degree of unreliability is set around the plaque regions 3012a and 3012b, and a particularly high degree of unreliability (that is, low reliability) is set for a section where the blood vessel 3001 is occluded by the particularly large plaque region 3012a (section with a low blood vessel certainty degree). The estimation function 163 specifies the finally acquired path as the running of the blood vessel core line 302.

The estimation function 163 may calculate the degree of certainty of the blood vessel core line based on the maximum value of the node-to-node search cost instead of calculating the degree of unreliability as an index different from the degree of certainty. In this case, both the pixel-by-pixel degree of certainty described in FIG. 3 and the node-to-node degree of certainty illustrated in FIG. 4 are collectively referred to as the degree of certainty. In FIG. 4, the degree of unreliability is defined as the maximum value of the node-to-node search cost, and the higher the value, the lower the reliability. On the other hand, the estimation function 163 may use the degree of reliability or the degree of certainty as an index in which the greater the value, the higher the reliability. For example, the estimation function 163 may calculate the degree of reliability or the degree of certainty so that the smaller the maximum value of the node-to-node search cost, the greater the degree of reliability or the degree of certainty. The estimation function 163 may also calculate the degree of reliability or the degree of certainty on the basis of grounds other than the node-to-node search cost.

The search for blood vessel running may be performed over an entire image without segmentation.

Referring to now back to FIG. 1, on the basis of the degree of certainty or the degree of unreliability (for example, the maximum value of the node-to-node search cost), the region definition function 153 defines regions where user's editing of the extraction result of the blood vessel core line 302 and the blood vessel wall in the medical image data is restricted or regions where user's editing is recommended. The region definition function 153 is an example of a definition unit.

The “restrictions on editing” include “suppression on editing” and “prohibition on editing”. The “suppression on editing” is to suppress the amount of editing by the user within a specified range. Specifically, the “suppression on editing” may be defined as restricting a movable range from an initial position to a specified distance by a user's manual operation. The region definition function 153 may set the movable range according to the degree of certainty or the degree of unreliability. For example, the region definition function 153 may set a narrow movable range when the degree of certainty is high and a wide movable range when the degree of certainty is low. The region definition function 153 may calculate the movable range by, for example, multiplying a predetermined reference value of the movable range by the reciprocal of the degree of certainty. The region definition function 153 may also define conditions for the movable range by a predetermined threshold. Another method of the suppression is not to restrict an editing range, but to reduce the amount of movement of an editing target in response to a user's editing operation, thereby restricting an editing speed. In this case, the region definition function 153 may calculate the degree of reduction in the amount of movement on the basis of the degree of certainty.

The “prohibition on editing” is to set the allowable range of movement to 0. For example, the region definition function 153 may prohibit editing for sections where the search cost is equal to or less than a predetermined value and user's editing can be determined to be unnecessary. The above restriction on editing may be applied not only when the user directly edits a target region, but also to a complementation process when the user edits an adjacent region. In this case, the problem that the target region is deformed due to the complementation when the adjacent region has been edited can be reduced.

The region where user's editing is restricted is an example of a first region in the present embodiment. The region where user's editing is recommended is an example of a second region in the present embodiment. Among the regions where user's editing is restricted, a region where user's editing is prohibited is an example of a third region in the present embodiment. Among the regions where user's editing is restricted, a region where user's editing is suppressed is an example of a fourth region in the present embodiment.

In the present embodiment, for example, the region definition function 153 defines, as the region where user's editing is prohibited, a region where the blood vessel core line 302 and the blood vessel wall can be extracted with sufficiently high accuracy by the extraction and determination function 152 without user's editing. The region definition function 153 also defines, as the region where user's editing is recommended, a region where the blood vessel core line 302 or the blood vessel wall may not have been extracted with sufficiently high accuracy by the automatic process of the extraction and determination function 152.

For example, the region definition function 153 defines a node section, in which the maximum value of the node-to-node search cost is equal to or less than a first threshold among respective node sections of the blood vessel core line 302, as a region where the user is prohibited from editing the blood vessel core line 302. The region definition function 153 also defines a node section, in which the maximum value of the node-to-node search cost is equal to or greater than a second threshold among the respective node sections of the blood vessel core line 302, as a region where the user is recommended to edit the blood vessel core line 302.

The region definition function 153 also defines a region, where the blood vessel certainty degree is equal to or greater than a third threshold, for example, among the blood vessel regions 301 extracted from the medical image data, as a region where the user is prohibited from editing the contour of the blood vessel 3001. The region definition function 153 also defines a region, where the blood vessel certainty degree is equal to or less than a fourth threshold, for example, among the blood vessel regions 301 extracted from the medical image data, as a region where the user is recommended to edit the contour of the blood vessel 3001. The values of the first to fourth thresholds are not particularly limited.

The region definition function 153 may define only one of the region where user's editing is restricted and the region where user's editing is recommended. The region definition function 153 may also classify the blood vessel region 301 of the medical image data into three categories: “edit prohibited”, “edit recommended”, and “others”, or define the degree of recommendation of editing for the entire blood vessel region 301 in a continuous or stepwise manner. For example, the region definition function 153 may express the degree of recommendation of editing by a numerical value such as %. The region definition function 153 may also classify the degree of recommendation of editing into stages of “low”, “medium”, and “high”, or “level 1”, “level 2”, and “level 3” for definition.

Referring to now back to FIG. 1, the image generation function 154 generates stretched multi planer reconstruction (SPR) image data of the blood vessel 3001 from the medical image data. For example, the image generation function 154 three-dimensionally reconstructs the blood vessel regions of coronary arteries in coronary artery CT image data and generates SPR images that are three-dimensional images of the coronary arteries. The SPR image data is one form of image data for display, and the format of the image data generated by the image generation function 154 is not limited to the SPR image data. For example, curved planer reconstruction (CPR) image data, multi planer reconstruction (MPR) image data, and shaded volume rendering (SVR) data may be adopted. The image generation function 154 may also generate two-dimensional image data as the image data for display.

The display control function 155 displays the extracted blood vessel core line 302 and blood vessel wall on the SPR image based on the SPR image data, together with information indicating regions where editing is prohibited or recommended. The display control function 155 may also display restriction on editing or suppression on editing. The SPR image is an example of a display image in the present embodiment.

More specifically, the display control function 155 causes the display 140 to display an edit screen of the blood vessel core line 302 and the blood vessel wall. The edit screen is a screen in which the segmentation results of the blood vessel core line 302 and the blood vessel wall are superimposed on the SPR image, together with the display of restriction or recommendation on editing. Only one of the blood vessel core line 302 and the blood vessel wall may be displayed on the edit screen.

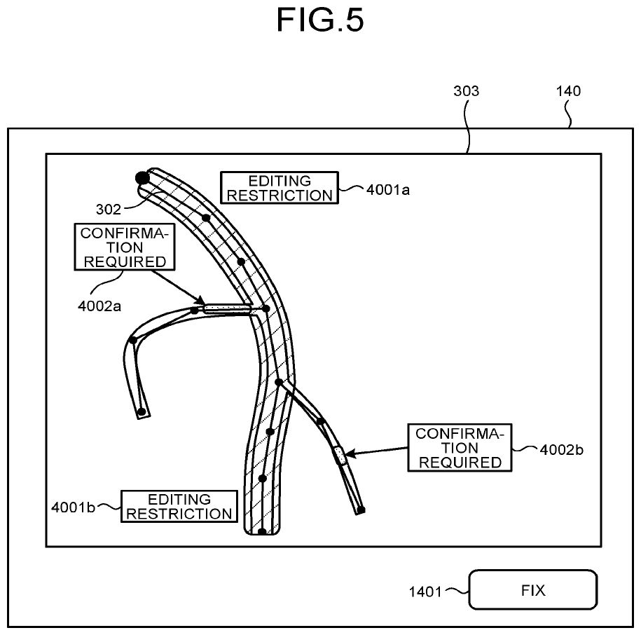

FIG. 5 is a diagram illustrating an example of the edit screen according to the first embodiment. In the example of the edit screen illustrated in FIG. 5, the display 140 displays an SPR image 303, the blood vessel core line 302 superimposed on the SPR image 303, messages 4001 indicating regions where editing is restricted, messages 4002a and 4002b indicating regions where confirmation is recommended, and a fix button 1401.

In the example illustrated in FIG. 5, the display control function 155 displays a mask on the region where editing is restricted. The mask display and the message 4001, which indicates the region where editing is restricted, are an example of information indicating the region where editing is restricted. The messages 4002a and 4002b, which indicate the regions where confirmation is recommended, are an example of information indicating the region where editing is recommended.

In the example illustrated in FIG. 5, the display control function 155 displays a section, in which the node-to-node search cost illustrated in FIG. 4 is equal to or greater than 0.5, as the region where editing is recommended. The display control function 155 also displays a section, in which the node-to-node search cost illustrated in FIG. 4 is equal to or less than 0.3, as the region where editing is restricted. The display control function 155 also displays the blood vessel core line 302 estimated in FIGS. 3 and 4 as is for a section in which the node-to-node search cost illustrated in FIG. 4 is greater than 0.3 and less than 0.5. The criteria for the region where editing is restricted and the region where editing is recommended are not limited to the example illustrated in FIG. 5.

The display mode of the region where editing is restricted and the region where editing is recommended is not limited to the message and the mask illustrated in FIG. 5, and the regions may be displayed by various marks, color changes, or the like.

Instead of information indicating the region where editing is restricted, information indicating the region where editing is prohibited or information indicating the region where editing is suppressed may also be displayed on the edit screen.

The display control function 155 may also display the degree of recommendation for editing on the SPR image 303 in numerical values on the edit screen. For example, the display control function 155 may display, on the SPR image 303, the maximum value of the node-to-node search cost for the blood vessel core line 302 illustrated in FIG. 4. In this case, the greater the displayed maximum value of the search cost, the higher the degree of recommendation for editing. The display control function 155 may also display, on the SPR image 303, the mean value for each range of the pixel-by-pixel degree of certainty described in FIG. 3. The display control function 155 may also display the mean value of the pixel-by-pixel blood vessel certainty degree between the nodes of the blood vessel core line 302, or may display the mean value of the pixel-by-pixel blood vessel certainty degree for each range in accordance with other criteria. The display control function 155 may also display, on the SPR image 303 on the edit screen, information indicating the degree of recommendation for editing in stages by classification such as “low”, “medium”, and “high”, or “level 1”, “level 2”, and “level 3”. The numerical value indicating the degree of recommendation for editing and the classification are examples of information indicating whether user's editing is required in the present embodiment.

Instead of displaying the degree of certainty or the value of the search cost as is, the display control function 155 may also display a converted value of the degree of certainty or the value of the search cost on the SPR image 303. The contents of the conversion process are not particularly limited. The conversion process may be performed by any one of the region definition function 153, the image generation function 154, and the display control function 155.

When the user operates a mouse or the like on the edit screen to correct the segmentation results of the blood vessel core line 302 or the blood vessel wall, the display control function 155 displays the corrected blood vessel core line 302 and blood vessel wall on the SPR image 303.

The fix button 1401 is an image button that can be pressed by the user with a mouse or the like. When the user presses the button, the segmentation results of the blood vessel core line 302 and the blood vessel wall are fixed. For example, after correcting the segmentation results of the blood vessel core line 302 or the blood vessel wall by operating the mouse, the user presses the fix button 1401 to fix the correction result. The edit screen is not limited to the example illustrated in FIG. 5, and may adopt a known user interface (UI).

The display control function 155 also causes the display 140 to display the degree of certainty or the search cost and information representing the region where the user made the editing, on a color map representing the results of blood vessel analysis by the analysis function 158 to be described below. The information representing the region where the user made the editing is, for example, an image surrounding a location where the user has corrected the blood vessel core line 302 or the blood vessel wall on the edit screen. The display mode of the information representing the region where the user made the editing is not limited to the image. When the user has corrected the blood vessel core line 302 or the blood vessel wall at the same location a plurality of times, the display mode may be different depending on the number of corrections. The display control function 155 may also display information representing the degree of correction as well as the presence or absence of correction. For example, information indicating the degree of correction can adopt an index, in which the greater the difference between the blood vessel core line 302 or the blood vessel wall before the correction and the blood vessel core line 302 or the blood vessel wall after the correction, the greater the numerical value, assignment of a color to a color map that darkens, or the like.

Referring now back to FIG. 1, the reception function 156 receives various user operations via the input interface 130.

When the user performs an editing operation in the region defined by the region definition function 153 where editing is restricted, the reception function 156 does not receive the operation, or converts the operation and receives the converted operation on the edit screen. For example, when the user performs an operation of correcting the blood vessel core line 302 or the blood vessel wall in the region where editing is prohibited, the reception function 156 does not receive the operation. When the user performs an operation of correcting the blood vessel core line 302 or the blood vessel wall in the region where editing is suppressed and when the operation is within a range set as the movable range, the reception function 156 receives the operation.

When the user performs an operation of correcting the blood vessel core line 302 or the blood vessel wall in the region where editing is suppressed and when the operation exceeds the range set as the movable range, the reception function 156 converts the operation into an operation up to an outer edge of the movable range and receives the converted operation. Alternatively, when the user performs an operation of correcting the blood vessel core line 302 or the blood vessel wall in the region where editing is suppressed, the reception function 156 may reduce an amount of movement of an editing target in response to the editing operation of the user and receive the reduced amount of movement of the edit target. For example, the reception function 156 may change the reduction rate of the movement amount according to the degree of certainty.

The model generation function 157 generates a model for blood vessel analysis on the basis of the fixed segmentation results of the blood vessel core line 302 and the blood vessel wall. The model for blood vessel analysis is, for example, a model for fluid structure analysis. A method for blood vessel analysis is not limited to the fluid structure analysis, and other analysis methods may be adopted.

The analysis function 158 performs blood vessel analysis on the blood vessel 3001 by using the model for blood vessel analysis. For example, the analysis function 158 performs the fluid structure analysis by using the model for fluid structure analysis.

The analysis function 158 generates a color map representing the results of the blood vessel analysis. The color map is, for example, image data that displays the blood vessels depicted in the SPR image data in different colors according to analysis result values. The image data representing the results of the blood vessel analysis is not limited to the color map. Examples of fluid parameters used as the analysis result values displayed on the color map may include blood pressure, blood flow, and fractional flow reserve (FFR) at each location in the blood vessel.

As a result of the fluid structure analysis performed by the analysis function 158, the accuracy of the segmentation results of the blood vessel core line 302 or the blood vessel wall may be low at locations where a flow rate is too low compared to the diameter of the blood vessel or locations where a local variation in pressure is too large. In this case, the certainty degree determination function 162 or the estimation function 163 may correct the degree of certainty according to the results of the fluid structure analysis. The display control function 155 may superimpose, on the color map representing the results of the blood vessel analysis, the degree of certainty corrected according to the results of the fluid structure analysis and the presence or absence of user's editing.

The flow of the process of analyzing the blood vessel structure performed by the image processing apparatus 100 configured as described above is described below.

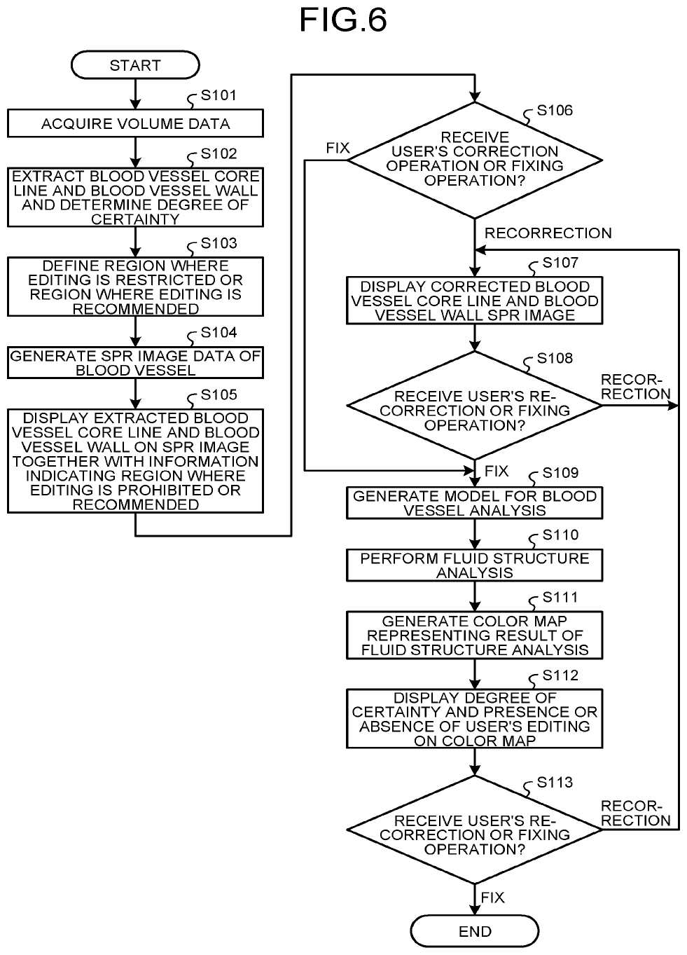

FIG. 6 is a flowchart illustrating an example of the flow of the process of analyzing the blood vessel structure according to the first embodiment.

First, the acquisition function 151 acquires volume data of coronary arteries obtained by capturing a subject from the medical image storage apparatus 500 or the medical image diagnostic apparatus 200 (S101).

Subsequently, the extraction and determination function 152 extracts the blood vessel core line 302 and the blood vessel wall from the acquired volume data. The extraction and determination function 152 also determines the degree of certainty of the blood vessel core line 302 and the blood vessel wall as a result of the extraction and estimation process (S102). The degree of certainty may be output by a trained model or may be the search cost by the Dijkstra's algorithm as described above.

Subsequently, the region definition function 153 defines regions where editing is restricted or regions where editing is recommended (S103). The region definition function 153 may define both a region where editing is prohibited and a region where editing is suppressed or define only one of the region where editing is prohibited and the region where editing is suppressed, as the regions where editing is restricted. The region definition function 153 may also define only one of the region where editing is restricted and the region where editing is recommended.

Subsequently, the image generation function 154 generates SPR image data of blood vessels from the acquired volume data (S104).

Subsequently, the display control function 155 causes the display 140 to display the extracted blood vessel core line 302 and blood vessel wall on the SPR image together with information indicating the region where editing is prohibited or recommended (S105). For example, the display control function 155 causes the display 140 to display the edit screen illustrated in FIG. 5.

When the reception function 156 receives a user's correction operation on the edit screen (“correction” at S106), the display control function 155 causes the display 140 to display the corrected blood vessel core line 302 and blood vessel wall on the SPR image (S107). The reception function 156 receives no user's correction operation in the region where editing is prohibited.

When the reception function 156 receives a user's operation of further re-correcting the corrected blood vessel core line 302 and blood vessel wall (“re-correct” at S108), the procedure returns to the process of S107. In this case, the display control function 155 causes the display 140 to display a region corrected by a previous operation of the user on the edit screen in a manner different from that of an uncorrected region.

When the reception function 156 receives an operation of fixing the corrected blood vessel core line 302 and blood vessel wall, for example, an operation of pressing the fix button 1401 on the edit screen (“fix” at S108), the model generation function 157 generates a model for blood vessel analysis on the basis of the fixed segmentation results of the blood vessel core line 302 and blood vessel wall (S109). Even when the user performs a fixing operation without performing a correction operation in the process of S106 (“fix” at S106), the procedure proceeds to the process of S109.

Subsequently, the analysis function 158 performs fluid structure analysis on the blood vessel 3001 by using the generated model for blood vessel analysis (S110).

Subsequently, the analysis function 158 generates a color map representing the results of the fluid structure analysis (S111).

Subsequently, the display control function 155 causes the display 140 to superimpose the degree of certainty and the presence or absence of user's editing on the color map (S112). The degree of certainty to be displayed on the color map may be the degree of certainty corrected according to the results of the fluid structure analysis.

When the reception function 156 receives a user's operation of re-correcting the blood vessel core line 302 and the blood vessel wall on the color map (“re-correct” at S113), the procedure returns to the process of 5107. The display control function 155 causes the display 140 to display a region corrected by a previous operation of the user on the edit screen in a manner different from that of an uncorrected region.

When the reception function 156 receives a user's fixing operation (“confirm” at S113), the blood vessel core line 302 and the blood vessel wall fixed by the user are stored in the storage circuitry 120, and the process of this flowchart ends.

In this way, according to the image processing apparatus 100 of the present embodiment, the structure of a target organ depicted in medical image data is estimated, and the degree of certainty representing the accuracy of estimation results of a structure of the target organ depicted in the medical image data is determined for each region of the target organ. On the basis of the degree of certainty, the image processing apparatus 100 defines a region where editing of the estimation results by a user is restricted. At least information indicating whether editing is required or information indicating a region where editing is restricted is caused to be displayed on a display image based on the medical image data. Therefore, according to the image processing apparatus 100 of the present embodiment, user's effort in manually editing segmentation results of medical images can be reduced.

For example, as a comparative example, in a case in which a user performs manual editing after automatic extraction of a blood vessel core line or a blood vessel wall, when the user is not able to ascertain the accuracy of automatic analysis, the user may have to waste time confirming all the blood vessels again before editing. Furthermore, the user may break highly accurate automatically extracted results by manual editing, which may reduce the accuracy of region extraction. On the other hand, according to the image processing apparatus 100 of the present embodiment, when the user performs manual editing, the user can easily ascertain a region to be edited, on the basis of information indicating whether editing is required or information indicating a region where editing is restricted, thereby reducing user's effort required for manual editing.

### First Modification of First Embodiment

In the edit screen of the first embodiment described above, the blood vessel core line 302 is superimposed on the SPR image 303 as illustrated in FIG. 5; however, blood vessel contour information for designating a blood vessel region, that is, the segmentation result of a blood vessel wall may be displayed on the SPR image 303.

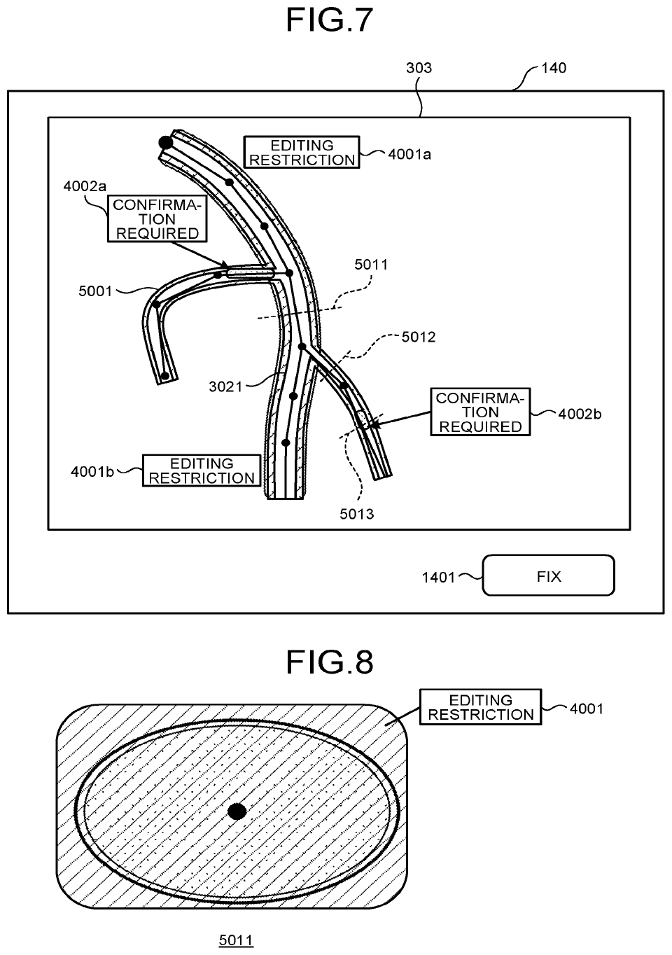

FIG. 7 is a diagram illustrating an example of an edit screen according to a first modification of the first embodiment. As illustrated in FIG. 7, the display control function 155 may cause blood vessel contour information 5001 to be displayed on the SPR image 303. The blood vessel contour information 5001 may be, for example, boundary information of a region where the blood vessel certainty degree is equal to or greater than a certain value. For example, the display control function 155 may cause boundary information of a region where the blood vessel certainty degree is greater than 0.2 to be displayed as the blood vessel contour information 5001. Alternatively, the region definition function 153 may calculate the blood vessel contour information 5001 from pixel values or the like around the blood vessel core line 302. The blood vessel contour information 5001 is an example of the structure of a target organ in the present modification.

In the edit screen illustrated in FIG. 7, editing restrictions on a user's operation are applied to the blood vessel core line 302 and the blood vessel contour information 5001.

In the edit screen, an image of a blood vessel in the cross-sectional direction may be displayed. FIGS. 8 to 10 are diagrams illustrating examples of blood vessel cross-sectional images corresponding to a first cutting position 5011, a second cutting position 5012, and a third cutting position 5013 in the SPR image 303 of FIG. 7, respectively.

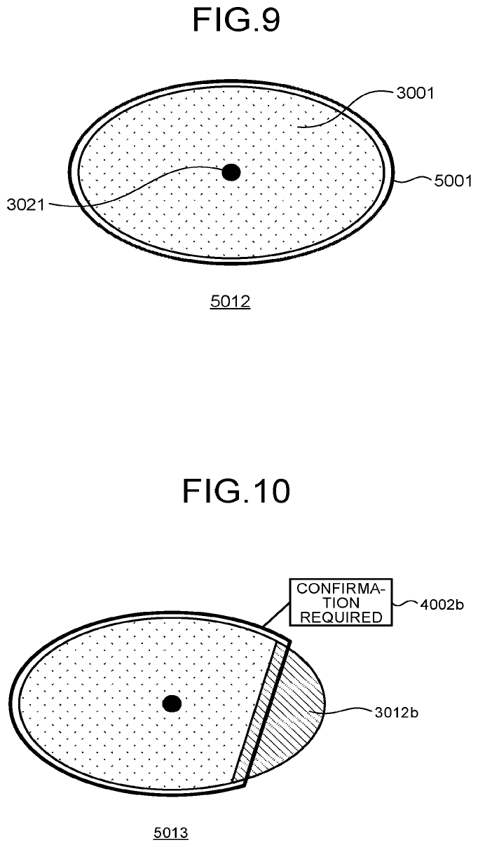

Since the first cutting position 5011 is a region where editing is restricted, FIG. 8 illustrates that editing restriction is applied to the blood vessel core line 302 and the contour of the blood vessel wall with respect to the entire cross section. Since the second cutting position 5012 is neither a region where editing is restricted nor a region where editing is recommended, FIG. 9 illustrates that the blood vessel core line 302 and the contour of the blood vessel wall are displayed in an editable state. Since the third cutting position 5013 is a region where editing is recommended, FIG. 10 illustrates information recommending editing of the blood vessel core line 302 and the contour of the blood vessel wall with respect to the entire blood vessel cross section, for example, the message 4002b or the like.

### Second Modification of First Embodiment

The process in which the region definition function 153 defines a region where editing is restricted or recommended may be performed in units of paths, that is, in units of branches of a blood vessel, instead of in units of a plurality of sections obtained by segmenting the path of the blood vessel 3001 between nodes.

For example, in order to determine a range in which user's editing needs to be restricted or recommended, the region definition function 153 acquires the maximum node-to-node search cost on each path and confirms the presence or absence of a section with a low degree of certainty on the path.

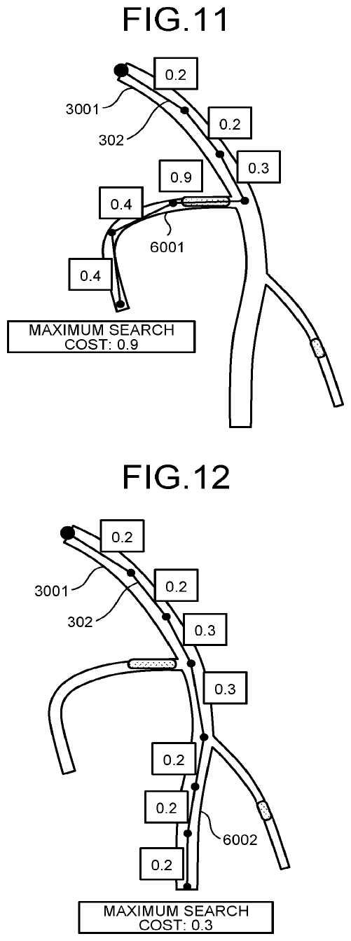

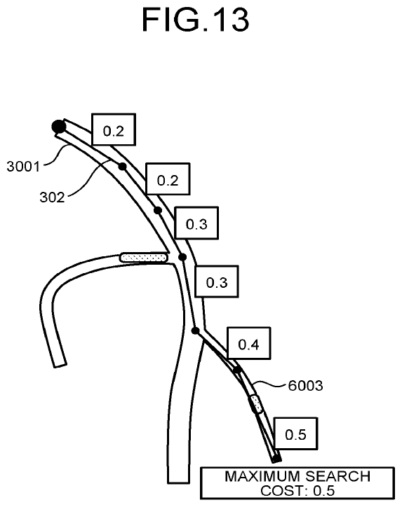

FIGS. 11 to 13 are diagrams illustrating examples of the node-to-node search cost for first to third branches of the blood vessel 3001 according to a second modification of the first embodiment.

The blood vessel 3001 illustrated in FIGS. 11 to 13 branches into three blood vessels 6001, 6002, and 6003. As illustrated in FIGS. 11 to 13, the maximum search costs for the three vessels 6001, 6002, and 6003 are “0.9”, “0.3”, and “0.5”, respectively. The region definition function 153 defines a path with a low maximum search cost, for example, a path with a maximum search cost of 0.3 or less, as a region where editing is restricted. The region definition function 153 also defines a path with a high maximum search cost, for example, a path with a maximum search cost of 0.6 or higher, as a region where editing is recommended.

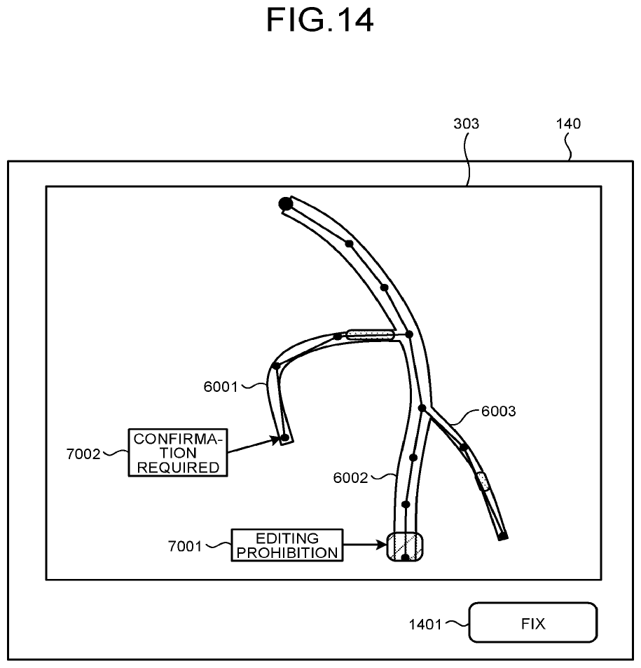

FIG. 14 is a diagram illustrating an example of an edit screen according to the second modification of the first embodiment. In the example illustrated in FIG. 14, branch-by-branch restrictions or recommendations on editing are displayed. For example, since the blood vessel 6001, which is a first branch, has a maximum search cost of 0.9, the display control function 155 causes a message 7002 recommending editing to be displayed in the vicinity of the blood vessel 6001. Since the blood vessel 6002, which is a second branch, has a maximum search cost of 0.3, the display control function 155 causes a message 7001 restricting editing to be displayed in the vicinity of the blood vessel 6002. Since the blood vessel 6003, which is a third branch, has neither a high nor a low maximum search cost, it is neither restricted nor recommended for editing.

The display control function 155 may cause the maximum search cost for each branch or individual node-to-node search costs to be displayed on the edit screen.

### Third Modification of First Embodiment

In the first embodiment described above, an example in which the plurality of relatively thin blood vessels 6001, 6002, and 6003 are branched from one large blood vessel 3001 is described; however, the shape of a target blood vessel is not limited to this configuration.

For example, the coronary artery includes three large blood vessels: the right coronary artery (RCA), the left circumflex artery (LCX), and the left anterior descending artery (LAD). In this case, the extraction function 161 automatically extracts RCA, LCX, and LAD from medical image data. The certainty degree determination function 162 and the estimation function 163 calculate the degree of certainty based on respective search costs or the like for RCA, LCX, and LAD. The region definition function 153 determines whether user's editing is restricted or recommended for each of RCA, LCX, and LAD. When a blood vessel recommended for editing exists among RCA, LCX, and LAD, the display control function 155 causes a recommended target blood vessel to be displayed on the edit screen.

For example, the display control function 155 may cause the display 140 to display a three-dimensional image including RCA, LCX, and LAD, and a two-dimensional image individually showing RCA, LCX, and LAD. In this case, the display control function 155 may cause, for example, only a two-dimensional image of a blood vessel recommended for editing among RCA, LCX, and LAD, and a two-dimensional image of a blood vessel for which editing is neither prohibited nor recommended, to be displayed in an editable state. The edit screen of individual blood vessels may be a three-dimensional image.

Alternatively, the display control function 155 may cause the display 140 to display a list of names of blood vessels recommended for editing among RCA, LCX, and LAD. In this case, when a user selects the name of a blood vessel from the list, an edit screen for the selected blood vessel may be displayed.

Alternatively, the display control function 155 may cause the display 140 to display a list of names of RCA, LCX, and LAD automatically extracted, and highlight only the name of a blood vessel recommended for editing among RCA, LCX, and LAD. RCA, LCX, and LAD are examples of blood vessels, and the configuration of the present modification can also be applied to other blood vessels.

### Fourth Modification of First Embodiment

In the first embodiment described above, an example in which information indicating restrictions or recommendations on editing, the degree of certainty, search cost, and the like are displayed on a blood vessel image on an edit screen is described; however, the reason for restrictions or recommendations on editing may also be displayed on the blood vessel image.

For example, the degree of certainty is reduced in locations where the shape of a blood vessel is complicated, such as around branches of the blood vessel. For example, the certainty degree determination function 162 may output information on the grounds for the degree of certainty as well as the degree of certainty. As an example, an output trained model that outputs, together with the degree of certainty, information on the grounds for the degree of certainty may be used, or a rule-based method or the like may be used. The display control function 155 also displays the reason for restrictions or recommendations on editing on the edit screen. For example, the display control function 155 may cause a message such as “due to the branching of a blood vessel, the accuracy of automatic extraction may be reduced” or “due to the branching of a blood vessel, confirmation and editing are recommended” to be displayed in the vicinity of the branch of the blood vessel.

### Fifth Modification of First Embodiment

In the first embodiment described above, a fluid structure analysis process is performed in the flow of the analysis process for the blood vessel structure; however, the fluid structure analysis process is not mandatory. The execution timing of the fluid structure analysis is also not limited to the example illustrated in FIG. 6. For example, the fluid structure analysis may be performed in advance before an edit screen of the blood vessel structure is displayed, or may be performed after the blood vessel structure is fixed.

### Second Embodiment

The first embodiment described above describes the estimation of the blood vessel core line 302 and the contour of the blood vessel wall, which is the boundary between an intravascular region and an extravascular region. This second embodiment describes the estimation of the shape of a lumen region of a blood vessel.

As in the first embodiment, a medical image processing system S of the present embodiment includes an image processing apparatus 100, a medical image diagnostic apparatus 200, and a medical image storage apparatus 500. The configuration of the image processing apparatus 100 is the same as in the first embodiment.

In the first embodiment, the image processing apparatus 100 restricts or recommends manual editing on the basis of the degree of certainty during blood vessel running search. On the other hand, the image processing apparatus 100 of the present embodiment restricts or recommends manual editing on the basis of the degree of certainty of an estimated lumen region of a blood vessel (that is, estimated lumen region). The contour of the lumen of the blood vessel is an example of the structure of a target organ in the present modification.

For example, the extraction function 161 of the present embodiment extracts the lumen region of a blood vessel from medical image data. The certainty degree determination function 162 of the present embodiment also determines the degree of certainty for each pixel or each region of the extracted lumen region. In the present embodiment, since the degree of certainty represents the accuracy of automatic extraction of the lumen of the blood vessel, it is also referred to as a lumen certainty degree.

The region definition function 153 defines, as a region where editing is restricted, a region with a high lumen certainty degree among regions estimated to be the lumen of the blood vessel. The region definition function 153 also defines, as a region where editing is recommended, a region with a low lumen certainty degree among regions estimated to be the lumen of the blood vessel.

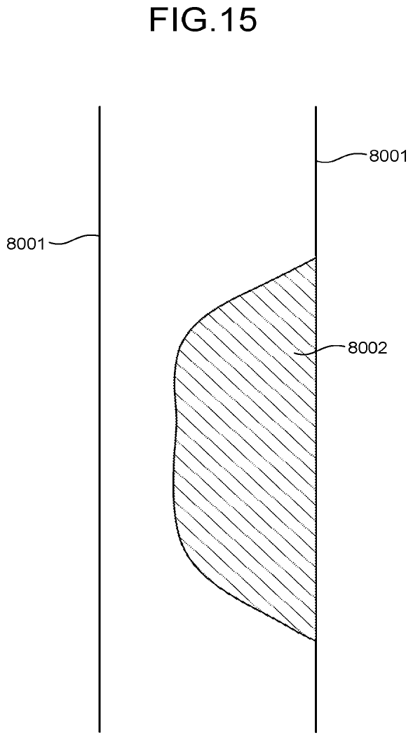

FIG. 15 is a diagram illustrating an example of medical image data obtained by capturing the lumen of the blood vessel according to the second embodiment. The medical image data illustrated in FIG. 15 includes a boundary 8001 between blood vessel regions and a plaque 8002.

The extraction function 161 of the present embodiment performs segmentation of three categories of “lumen”, “plaque”, and “background” on medical image data. The segmentation method may use machine learning, threshold determination, or the like as in the first embodiment; however, in the present embodiment, at least certainty degree maps of “lumen”, “plaque”, and “background” are estimated for use. That is, the extraction function 161 compares the certainty degree maps of “lumen”, “plague”, and “background” obtained from the medical image data, and defines a region with the highest lumen certainty degree as an estimated lumen region.

The display control function 155 of the present embodiment displays the lumen region estimated by the extraction function 161 on an edit screen.

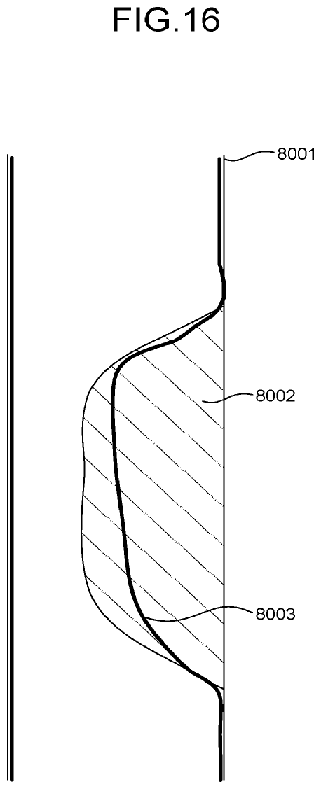

FIG. 16 is a diagram illustrating an example of a result of estimating the lumen region of the blood vessel according to the second embodiment. An image illustrated in FIG. 16 is, that is, the result of superimposing a boundary 8003 of the estimated lumen region segmented by the extraction function 161 on the medical image data illustrated in FIG. 15. Since the estimated lumen region is obtained by estimation, it may be different from an actual lumen shape, and particularly, may be greatly different from the actual lumen shape in regions where automatic extraction is difficult, such as around the plaque 8002.

The region definition function 153 of the present embodiment acquires a lumen certainty degree map from the extraction and determination function 152. Then, the region definition function 153 defines, on the edit screen, a portion of the estimated lumen region, where the accuracy of a region boundary surface is high, as a region where manual editing is restricted. The region definition function 153 determines the accuracy of the region boundary surface on the basis of the difference in the degree of certainty inside and outside the region interface. For example, when the difference between the lumen certainty degrees on both sides of the boundary 8003 of the estimated lumen region is large, the region definition function 153 determines that the accuracy of the boundary 8003 is high. As an example, when the difference between the lumen certainty degrees is equal to or greater than 0.8, the region definition function 153 restricts editing of the boundary 8003 of the estimated lumen region.

The region definition function 153 defines a portion of the estimated lumen region, where the accuracy of the region boundary surface is low, as a region where editing is recommended. For example, when the difference between the lumen certainty degrees on both sides of the boundary 8003 of the estimated lumen region is small, the region definition function 153 determines that the accuracy of the boundary 8003 is low. As an example, when the difference between the lumen certainty degrees is equal to or less than 0.5, the region definition function 153 recommends editing of the boundary 8003 of the estimated lumen region.

The display control function 155 of the present embodiment causes information indicating a region where user's editing is restricted and a region where user's editing is recommended to be displayed on the edit screen of the boundary 8003 of the estimated lumen region.

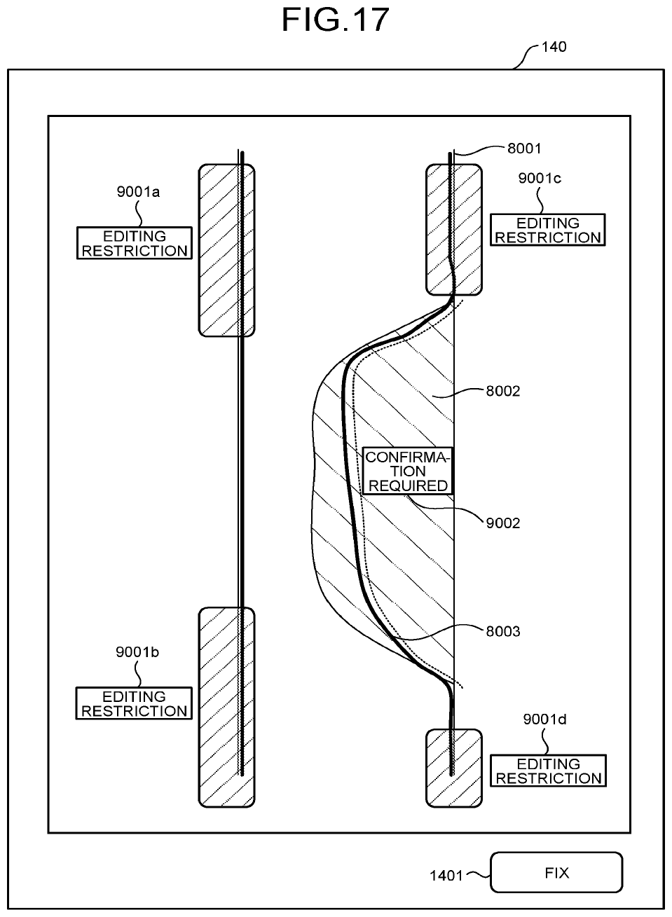

FIG. 17 is a diagram illustrating an example of the edit screen according to the second embodiment.

The display control function 155 causes messages 9001a to 9001d indicating restrictions on editing to be displayed in a region defined by the region definition function 153 as a region where user's editing is restricted with respect to the boundary 8003 of the estimated lumen area. The display control function 155 may also cause a mask image or the like to be displayed in the region defined as the region where user's editing is restricted. The display control function 155 also causes a message 9002 recommending editing to be displayed in a region defined by the region definition function 153 as a region where user's editing is recommended.

As described in the first modification of the first embodiment, the display control function 155 may also cause a blood vessel cross-sectional image to be displayed on the edit screen.

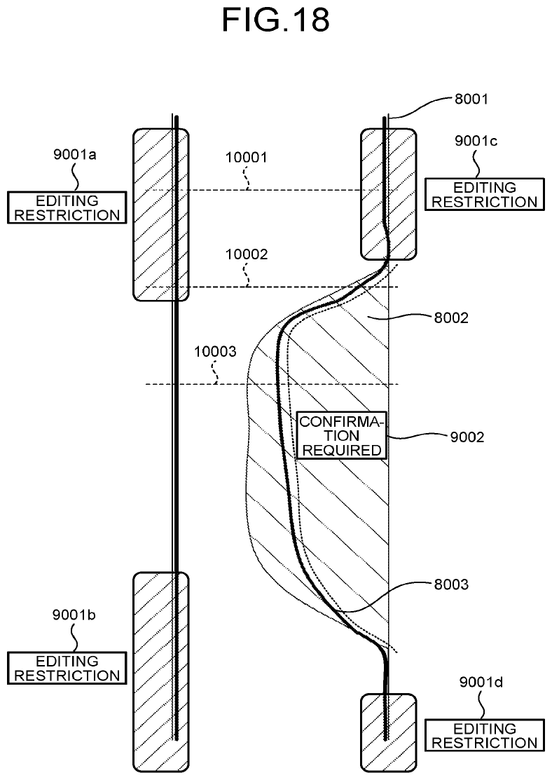

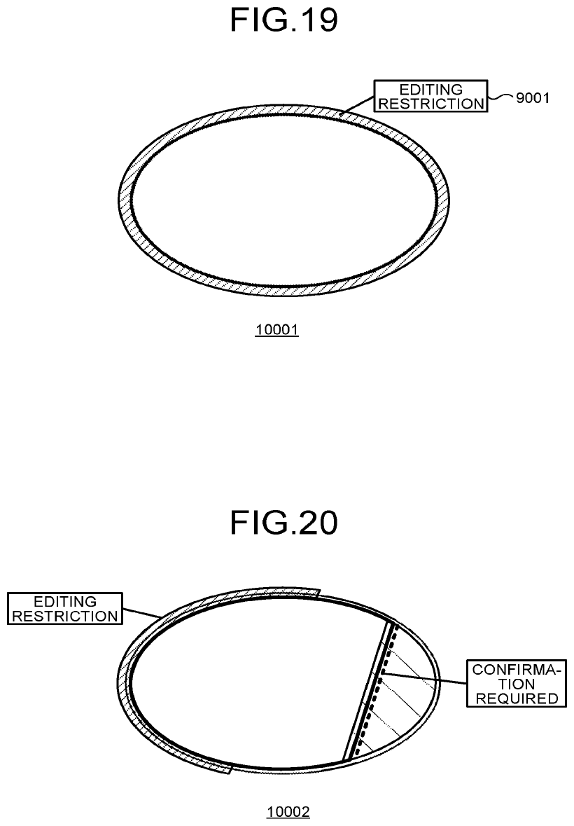

FIG. 18 is a diagram illustrating an example of a first cutting position 10001 to a third cutting position 10003 on the edit screen according to the second embodiment. FIGS. 19 to 21 illustrate examples of blood vessel cross-sectional images corresponding to the first cutting position 10001 to the third cutting position 10003 in FIG. 18, respectively. The blood vessel cross-sectional images are cross-sections obtained by cutting the first cutting position 10001 to the third cutting position 10003 illustrated in FIG. 18 at right angles to the running direction of the blood vessel.

The setting of regions where editing is restricted and recommended may be performed partially or uniformly on the blood vessel cross section. For example, the region definition function 153 may apply an editing restriction to a region where the difference between the lumen certainty degrees on both sides of the cross-sectional perimeter is greater than a fifth threshold within the same cross-section, and recommend editing for a region where the difference between the lumen certainty degrees on both sides of the cross-sectional perimeter is less than a sixth threshold. The values of the fifth and sixth thresholds are not particularly limited.

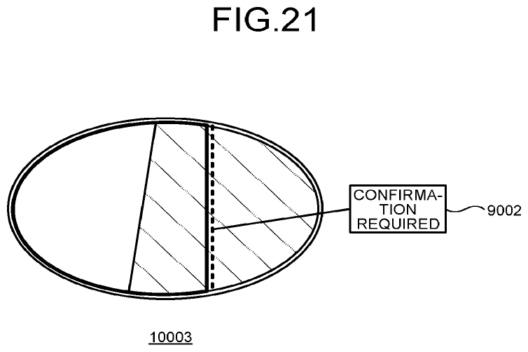

As illustrated in FIG. 19, the cross-section at the first cutting position 10001 is a region where editing is restricted in the entire cross-sectional perimeter because the difference between the lumen certainty degrees on both sides of the cross-sectional perimeter is greater than the fifth threshold. As illustrated in FIG. 20, the cross-section at the second cutting position 10002 has a mixture of regions where the difference between the lumen certainty degrees on both sides of the cross-sectional perimeter is greater than the fifth threshold and smaller than the sixth threshold, so editing is restricted in some regions and recommended in some other regions. As illustrated in FIG. 21, the cross-section of the third cutting position 10003 has a mixture of regions where editing is neither restricted nor recommended and regions where editing is recommended, so the display control function 155 causes the message 9002 recommending editing to be displayed only in the regions where editing is recommended.

Alternatively, when even a part of the cross-sectional perimeter of one cross-section is a region recommended for editing, the region definition function 153 may set the entire cross-sectional perimeter as a region where editing is recommended.

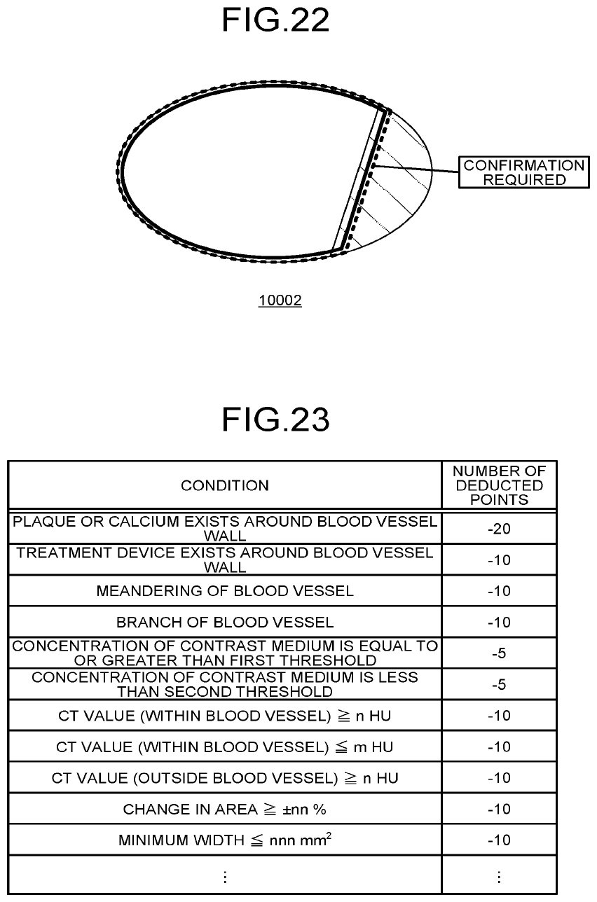

FIG. 22 is a diagram illustrating another example of the blood vessel cross-sectional image corresponding to the second cutting position in FIG. 18. The cross-section at the second cutting position 10002 has a mixture of regions where the difference between the lumen certainty degrees on both sides of the cross-sectional perimeter is greater than the fifth threshold and smaller than the sixth threshold, so the entire cross-sectional perimeter is set as a region where editing is recommended in the example illustrated in FIG. 22.

In this way, according to the image processing apparatus 100 of the present embodiment, even when the shape of a lumenal region of a blood vessel is to be estimated, user's effort in manually editing segmentation results of medical images can be reduced as in the first embodiment.

The region definition function 153 may use the degree of certainty of the estimated lumen region, instead of the accuracy of the boundary 8003 of the estimated lumen region, when determining whether to restrict or recommend editing. The region definition function 153 may acquire the degree of certainty of the estimated lumen region around a region to be edited, determine the estimated lumen region as a region where editing is restricted when the minimum value of the degree of certainty is equal to or greater than a seventh threshold, and determine the estimated lumen region as a region where editing is recommended when the minimum value of the degree of certainty is equal to or less than an eighth threshold. The seventh threshold for the minimum value of the lumen certainty degree is, for example, 0.8, and the eighth threshold for the minimum value of the lumen certainty degree is, for example, 0.5, but are not limited to such values.

The region definition function 153 may also limit a region where editing is restricted or recommended to the vicinity of a plaque where estimation of the lumen region is difficult. For example, the region definition function 153 acquires the lumen certainty degree map from the extraction and determination function 152, and defines a region with the highest degree of certainty of plaque as an estimated plaque region. The region definition function 153 may perform a process of setting a region, where editing is restricted or recommended, only at an interface between the estimated plaque region and the estimated lumen region.

When the extraction and determination function 152 uses a region boundary estimation method such as a graph cut method for the segmentation of the lumen region, boundary cutting cost information in the region boundary estimation method may be used as the blood vessel certainty degree. In this case, for example, the extraction and determination function 152 estimates a lumen certainty degree map for medical image data, generates a graph in which the difference in the degree of certainty in the lumen certainty degree map is reflected in the cutting cost, and performs a graph cut. In such a case, the extraction and determination function 152 sets a larger cost as the difference in the degree of certainty is smaller. Then, the extraction and determination function 152 sets the inside of the cut boundary as the estimated lumen region.

When such a method is adopted, the region definition function 153 acquires the cost for each cut boundary on the basis of graph information when the graph cut is performed by the extraction and determination function 152, and sets a boundary with a low cost as an edit-restricted target and a boundary with a high cost as an edit-recommended target.

### First Modification of First and Second Embodiments

In the first and second embodiments described above, a blood vessel is used as an example of a target organ; however, the target organ is not limited to the blood vessel. For example, the target organ may be any organ with a tubular structure and may be a lumen of a blood vessel, lymphatic vessel, ureter, esophagus, bronchus, digestive tract, stomach, or the like.

### Second Modification of First and Second Embodiments

In the first and second embodiments described above, the extraction and determination function 152 simultaneously performs the segmentation of a target region and the determination of the degree of certainty; however, the extraction and determination function 152 may perform the determination of the degree of certainty as a separate process after completing the segmentation of the target region.

For example, the certainty degree determination function 162 may determine the degree of certainty in each region of the target organ by using a rule-based method. In an initial state, the degree of certainty of all regions is set to the same value, for example, “100”, and the certainty degree determination function 162 may produce the degree of certainty of all regions satisfying point deduction conditions for the degree of certainty, thereby calculating the degree of certainty of each region.

FIG. 23 is a diagram illustrating an example of a table defining point deduction conditions for the degree of certainty according to the second modification of the first and second embodiments. The table stores, among the characteristics of a blood vessel and structures around the blood vessel, conditions causing a reduction in the accuracy of automatic extraction of the blood vessel in association with the number of deducted points indicating the degree to which the accuracy is reduced. The table is stored in the storage circuitry 120, for example. The certainty degree determination function 162 performs a certainty degree subtraction process on the basis of the table. The display control function 155 may also display conditions, to which each region corresponds, on the edit screen as the reason for the degree of certainty in each region. The contents of the conditions and the number of deducted points illustrated in FIG. 23 are examples and are not limited thereto. When the target organ is not a blood vessel, the content of the conditions are different.

The operation method of the degree of certainty in the rule-based method is not limited to the deduction method. For example, a table defining point addition conditions for the degree of certainty may be used. In an initial state, the degree of certainty of all regions may not have the same value. For example, the certainty degree determination function 162 may use, as initial setting, the pixel-by-pixel degree of certainty calculated by the extraction function 161 or the search cost calculated by the estimation function 163, and further deduct or add points based on a rule.

### Third Modification of First and Second Embodiments

In the first and second embodiments described above, the display control function 155 causes information indicating a region where user's editing is restricted and a region where user's editing is recommended to be displayed on the edit screen; however, the display control function 155 may not cause the region where user's editing is restricted to be displayed. Even in this case, user's operations in the region where user's editing is restricted are restricted.

### Fourth Modification of First and Second Embodiments

In the first and second embodiments described above, the edit screen is displayed on the display 140 of the image processing apparatus 100; however, the edit screen may also be displayed on a display of another information processing apparatus. In this case, the display of the another information processing apparatus is an example of a display unit.

Various data handled in the present specification are typically digital data.

According to at least one of the embodiments described above, user's effort in manually editing segmentation results of medical images can be reduced.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus comprising a processor, wherein
the processor is configured to
acquire medical image data,
estimate a structure of a target organ depicted in the medical image data,
determine, for each region of the target organ, a degree of certainty representing accuracy of an estimation result of the structure of the target organ depicted in the medical image data, and
define a region where editing of the estimation result by a user is restricted, on the basis of the degree of certainty.

2. The image processing apparatus according to claim 1, wherein the processor causes at least information indicating whether the editing is necessary or information representing a region where the editing is restricted to be displayed on a display image based on the medical image data.

3. The image processing apparatus according to claim 2, wherein, the processor
defines at least one of a first region where the editing by the user is restricted and a second region where the editing by the user is recommended, in the structure of the target organ, on the basis of a distribution of the degree of certainty in the structure of the target organ, and
superimposes, on the display image, the estimated structure of the target organ and information representing a range corresponding to the first region or the second region in the structure, causing a display unit to display superimposed information.

4. The image processing apparatus according to claim 3, wherein the first region includes at least one of a third region where the editing by the user is prohibited and a fourth region where an amount of the editing by the user is suppressed within a specified range.

5. The image processing apparatus according to claim 4, wherein the processor does not receive an editing operation of the user for a range included in the third region in the structure of the target organ displayed on the display unit, receives an editing operation of the user for a range included in the fourth region only when the amount of the editing is within the specified range, and receives an editing operation of the user for a range not included in the first region.

6. The image processing apparatus according to claim 4, wherein the processor reduces an amount of movement of an edit target in response to an editing operation of the user for a range included in the fourth region and receives the reduced amount of movement of the edit target.

7. The image processing apparatus according to claim 6, wherein the processor changes a reduction rate of the amount of movement on the basis of the degree of certainty.

8. The image processing apparatus according to claim 2, wherein the information indicating whether the editing is necessary is a numerical value or classification representing a degree of recommendation for editing.

9. The image processing apparatus according to claim 8, wherein the numerical value representing the degree of recommendation for editing is the degree of certainty or a numerical value calculated from the degree of certainty by a conversion process.

10. The image processing apparatus according to claim 1, wherein
the target organ is a blood vessel,
the processor estimates, as the structure, running of the blood vessel depicted in the medical image data, and
the degree of certainty is a path search cost for each section of the blood vessel in estimating the running of the blood vessel.

11. The image processing apparatus according to claim 1, wherein
the target organ is a blood vessel,
the processor estimates, as the structure, a contour of an outer wall of the blood vessel depicted in the medical image data, and
in estimating a contour of a lumen of the blood vessel, the degree of certainty represents, for each pixel, an accuracy of estimating the contour of the lumen.

12. The image processing apparatus according to claim 1, wherein
the target organ is a blood vessel,
the processor estimates, as the structure, a contour of a lumen of the blood vessel depicted in the medical image data by a region boundary estimation method, and
the degree of certainty is a cutting cost of a region boundary surface in the region boundary estimation method.

13. The image processing apparatus according to claim 1, wherein the structure of the target organ includes at least one of a blood vessel region, a blood vessel contour, and a blood vessel core line.

14. The image processing apparatus according to claim 1, wherein
the target organ is a blood vessel, and
the processor extracts at least one of a lumen of the blood vessel and a plaque in the blood vessel from the medical image data.

15. An image processing method comprising:
acquiring medical image data,
estimating a structure of a target organ depicted in the medical image data,
determining, for each region of the target organ, a degree of certainty representing accuracy of an estimation result of the structure of the target organ depicted in the medical image data, and
defining a region where editing of the estimation result by a user is restricted, on the basis of the degree of certainty.

16. A computer program product having a computer readable medium including programmed instructions, wherein the instructions, when executed by a computer, cause the computer to execute:
acquiring medical image data,
estimating a structure of a target organ depicted in the medical image data,
determining, for each region of the target organ, a degree of certainty representing accuracy of an estimation result of the structure of the target organ depicted in the medical image data, and
defining a region where editing of the estimation result by a user is restricted, on the basis of the degree of certainty.
